(19) United States
(12) Patent Application Publication
(10) Pub. No.: US 2002/0136155 A1
(43) Pub. Date: Sep. 26, 2002

(54) CD safe to hold

(76) Inventor: Chieh-Ho Chen, Yung-Kang City (TW)

Correspondence Address: Chieh-Ho CHEN, P.O. Box 90, Tainan City, 704, TW

(21) Appl. No.: 09/798,975

(22) Filed: Mar. 6, 2001

(51) Int. Cl. G11B 3/70; G11B 5/84; G11B 7/26

(52) U.S. Cl. 369/272; 369/280

(57) ABSTRACT

A CD safe to hold has its circumferential edge automatically cut arc-shaped or cut in a plurality of angles or formed arc-shaped at an upper and a lower side for convenience of holding and placing it easily and without cutting a user's hand by its circumferential edge.

### BACKGROUND OF THE INVENTION

1. Field of the Invention

This invention relates to a CD safe to hold or place, particularly to one with its circumferential edge formed arc-shaped, or cut into plural angles, or formed in a curved upper and a curved lower side, convenient to hold and place, possible to avoid potential cutting a user's hand by its circumferential edge.

2. Description of the Prior Art

Prosperity in industry and commerce and promotion in living quality give rise to a great change on man's life; nowadays man's life is full of variety, and recreation activities are more appreciated than ever before. For instance, art and music have played an important role in releasing a man from pressure caused by market competition and busy work. However, safety in using musical articles should be paid attention to. For the present, CD on market generally has its circumferential edge formed into sharp right angle at an upper and lower side 11, 12, as shown in FIG. 2, liable to cut and hurt a user's hand if a hand carelessly holds it, and also unsafe to take out or place back in a CD case.

### SUMMARY OF THE INVENTION

The objective of the invention is to offer a CD convenient for holding and placing, possible to avoid cutting a user's hand by its circumferential edge.

One feature of the invention is a CD with its circumferential edge formed arc-shaped.

Another feature of the invention is a CD with its circumferential edge cut in plural angles.

One more feature is a CD with an upper and lower sides of its circumferential edge formed in an arc shape.

### BRIEF DESCRIPTION OF DRAWINGS

This invention will be better understood by referring to the accompanying drawings, wherein:

FIG. 1 is a perspective view of a conventional known CD;

FIG. 2 is a magnified side view of the circumferential edge of the conventional known CD;

FIG. 3 is a magnified side view of a first embodiment of a CD in the present invention;

FIG. 4 is a magnified side view of a second embodiment of a CD in the present invention;

FIG. 5 is a magnified side view of the third embodiment of a CD in is the present invention;

FIG. 6 is a magnified side view of the circumferential edge of a CD under held condition in the present invention;

FIG. 7 is a magnified side view of the second embodiment of a CD under held condition in the present invention; and,

FIG. 8 is a magnified side view of the third embodiment of a CD under held condition in the prevention.

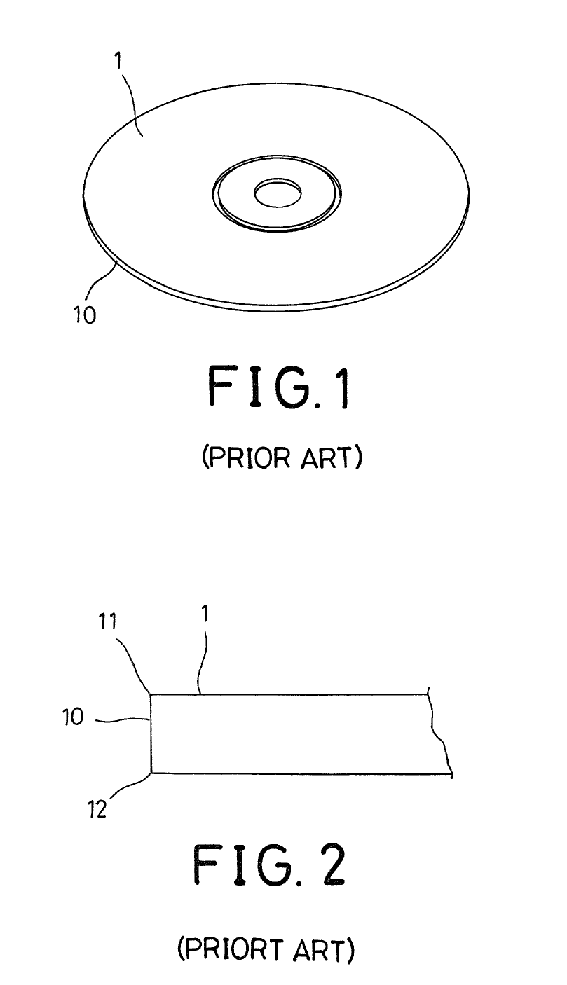

### DETAILED DESCRIPTION OF THE PREFERRED EMBODIMENT

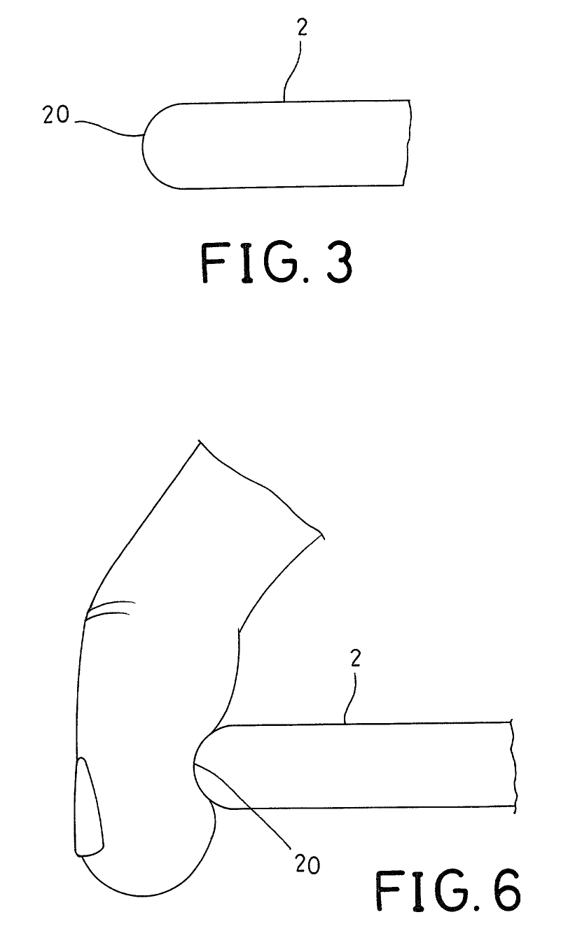

A first embodiment of a CD 2 is shown in FIG. 3, having its circumferential edge 20 is automatically cut arc-shaped by means of a mechanical tool.

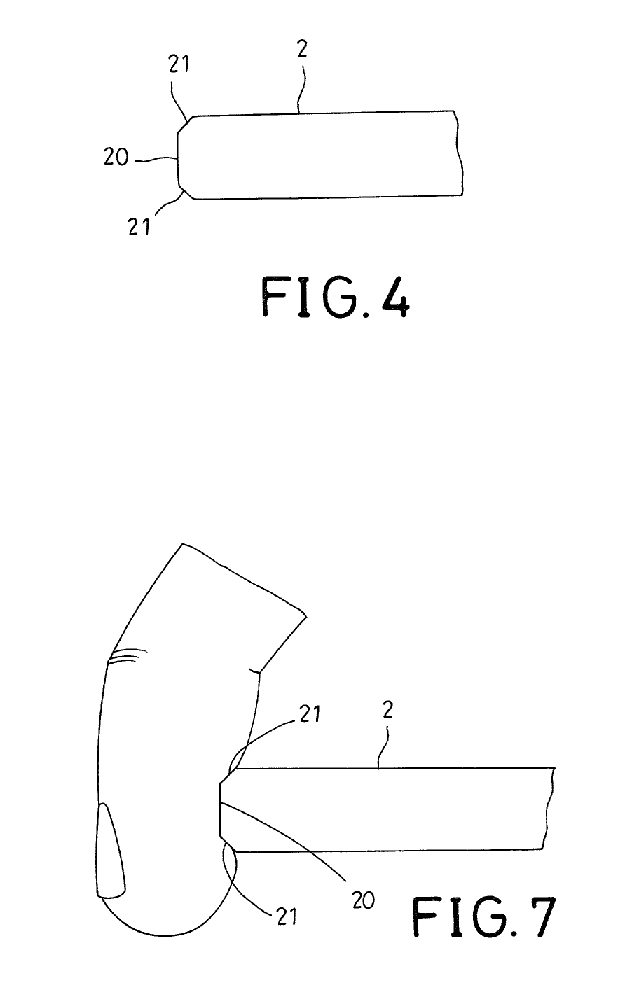

A second embodiment is shown in FIG. 4, its circumferential edge 20 is automatically cut in plural angles by means of a mechanical tool.

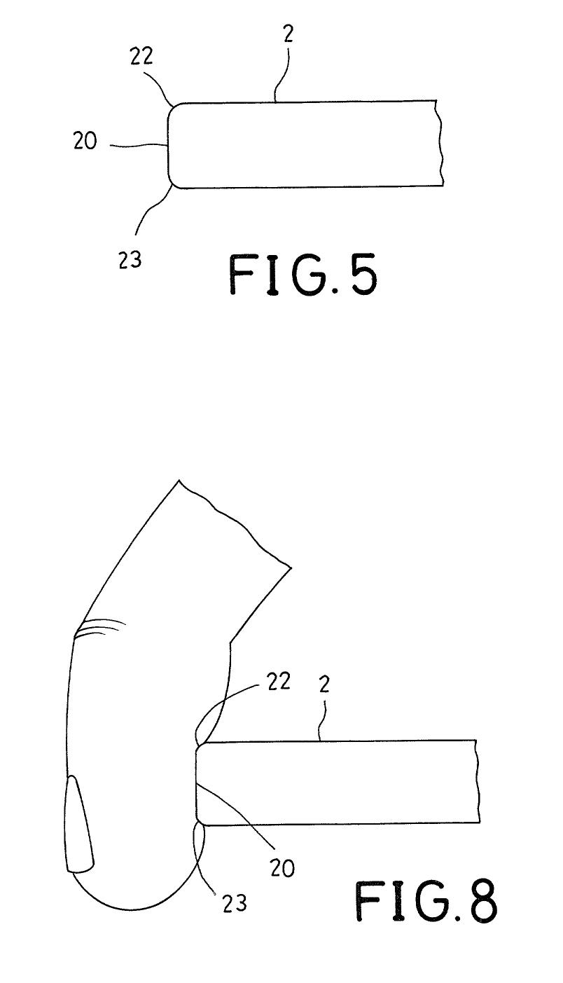

In a third embodiment, as shown in FIG. 5, both an upper and a lower side of the circumferential edge 20 of a CD are automatically cut arc-shaped by means of a mechanical tool.

In using, referring to FIG. 6,7, and 8, a CD can easily be taken out or placed in a CD case without any fears of cutting a user's hand due to the arc-shaped or plural angled circumferential edge of a CD.

While the preferred embodiments of the invention have been described above, it will be recognized and understood that various modifications way be made therein, and the appended claims are intended to cover all such modifications that may fall within the spirit and scope of the invention.

What is claimed is:

1. A CD safe to hold comprising:
a circumferential edge formed arc-shaped, facilitating holding and placing and avoiding cutting a user's hand when a hand holds it.

2. The CD safe to hold as claimed in claim 1, wherein said circumferential edge of said CD is automatically cut in a plurality of angles to hold or place it conveniently without cut.

3. The CD safe to hold as claimed in claim 1, wherein an upper and a lower side of said circumferential edge of said CD are automatically cut arc-shaped, impossible to cut a user's hand by said circumferential edge.
